(19) United States
(12) Patent Application Publication
(10) Pub. No.: US 2006/0114761 A1
(43) Pub. Date: Jun. 1, 2006

(54) Reproducing apparatus and reproducing method

(75) Inventors: Hideki Ohkita, Kunitachi-shi (JP); Takashi Kokubo, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/289,536

(22) Filed: Nov. 30, 2005

(30) Foreign Application Priority Data
Nov. 30, 2004 (JP) 2004-347745

(51) Int. Cl. G11B 21/08

(52) U.S. Cl. 369/30.01

(57) ABSTRACT

To provide a reproducing apparatus comprising a communication unit configured to perform communication with a device on a network, a reproducing unit configured to decode a content in units of packets and reproduce it, and a control unit configured to control to acquire management information (IFO) of the content stored in the device on the network by controlling the communication unit, to display the substance of the content on the basis of the management information, to receive a reproduction instruction from a user in accordance with the display, to acquire the content on the device in units of packets via the communication unit in accordance with the reproduction instruction, and to reproduce the packet of the acquired content by the reproducing unit.

### CROSS-REFERENCE TO RELATED APPLICATIONS

This application is based upon and claims the benefit of priority from prior Japanese Patent Application No. 2004-347745, filed Nov. 30, 2004, the entire contents of which are incorporated herein by reference.

### BACKGROUND OF THE INVENTION

1. Field of the Invention

The present invention relates to a reproducing apparatus having a network function, and specifically, to a reproducing apparatus a reproducing method for arbitrarily acquiring and reproducing a content with reference to management information of the content on a network.

2. Description of the Related Art

In recent years, a content targeted for reproduction has been made into a digital data also in a digital appliance such as a television and a hard disk recorder, so that, for example, utilization of a network such as a LAN at home has been largely expected. This is applicable to a case where moving image information is acquired from a moving image server site via the Internet in accordance with operation of a user, and the acquired moving image information is reproduced by the user's device.

A patent document 1 (Jpn. Pat. Appln. KOKAI Publication No. 2002-77870) describes to acquire content information from a start position based on representative image data from an operation server site, and thereby, the content information can be easily downloaded from an appropriate position.

In this case, a prior art described in the patent document 1 covers relatively short moving image information to be transmitted and received through the Internet, and it refers to a representative image. However, for example, it is assumed that the user has a plurality of recorders at home, and he or she acquires a content stored into a hard disk recorder in a bedroom at 2F from a television in a living room at 1F, and views the content in the television in the living room. In this case, the information of the content has a relatively large capacity, for example, an MPEG-2TS (Transport Stream). In addition, a movie sometimes has thirty chapters and its reproduction time exceeds two hours. Therefore, there is a problem such that it takes a long transmission time and bears a heavy burden when all contents are transmitted and a heavy burden is given to the device if a representative image is managed at a start position.

### BRIEF SUMMARY OF THE INVENTION

An embodiment of the present invention is a reproducing apparatus comprising: a communication unit configured to perform communication with a device on a network; a reproducing unit configured to decode a content in units of packets and reproduce it; and a control unit configured to control to acquire management information of the content stored in the device on the network by controlling the communication unit, to display the substance of the content on the basis of the management information, to receive a reproduction instruction from a user in accordance with the display, to acquire the content on the device in units of packets via the communication unit in accordance with the reproduction instruction, and to reproduce the packet of the acquired content by the reproducing unit.

### BRIEF DESCRIPTION OF THE SEVERAL VIEWS OF THE DRAWING

FIG. 1 is a block diagram showing an example of a configuration of a digital television apparatus using a content transmission method according to an embodiment of the invention;

FIG. 2 is a network diagram showing an example of a configuration of a network using the content transmission method according to the embodiment of the invention;

FIG. 3 is a block diagram showing an example of a configuration of a recording and reproducing apparatus using the content transmission method according to the embodiment of the invention;

FIG. 4 is a flowchart showing an example of the content transmission method according to the embodiment of the invention;

FIG. 5 is a flowchart showing another example of the content transmission method according to the embodiment of the invention;

FIG. 6 is a flowchart showing an example of a Transmit Packet decision step based on GOP in the content transmission method according to the embodiment of the invention;

FIG. 7 is an explanatory view showing a step of designating a content packet and a step of transmitting the content packet in the content transmission method according to the embodiment of the invention;

FIG. 8 is an explanatory view showing the step of designating the content packet and another step of transmitting the content packet in the content transmission method according to the embodiment of the invention;

FIG. 9 is an explanatory view showing an example of a data configuration of content information that is subject of the content transmission method according to the embodiment of the invention;

FIG. 10 is an explanatory view showing an example of a data configuration of content information that is subject of the content transmission method according to the embodiment of the invention; and

FIG. 11 is an explanatory view showing an example of a title screen displayed by a recording and reproducing apparatus using the content transmission method according to the embodiment of the invention.

### DETAILED DESCRIPTION OF THE INVENTION

One embodiment of the present invention will be specifically described below with reference to the drawings.

Functions of browsing and viewing a content as the embodiment of the present invention can be applied to an image device mainly having a network function. Here, the embodiment will be described in detail below taking examples of a digital television apparatus 11 having a representative network function and a function of recording and reproducing a content and a recording and reproducing apparatus 110 such as a hard disk recorder.

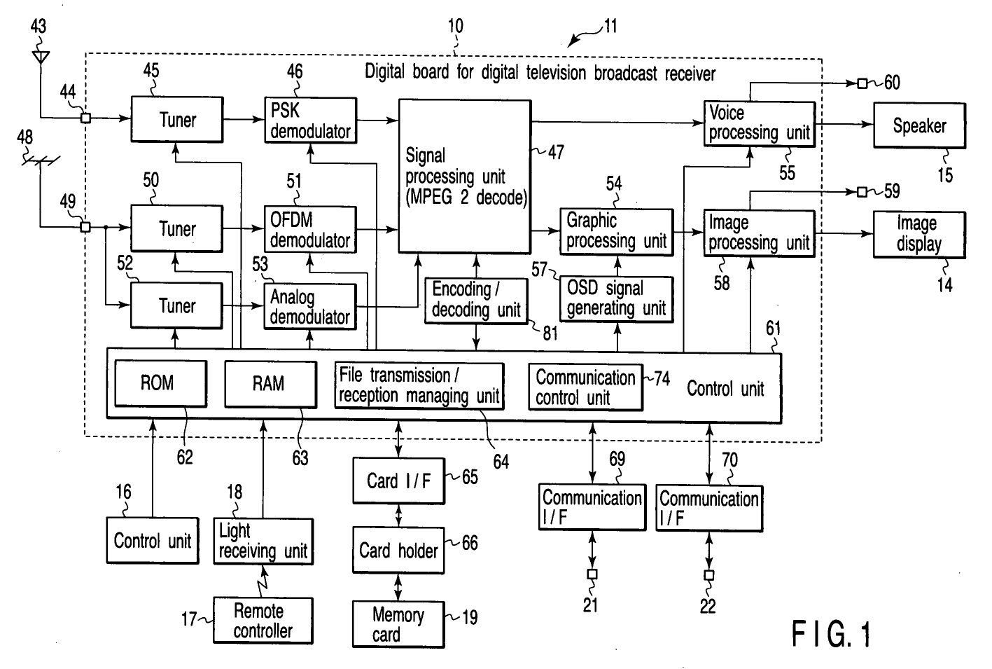

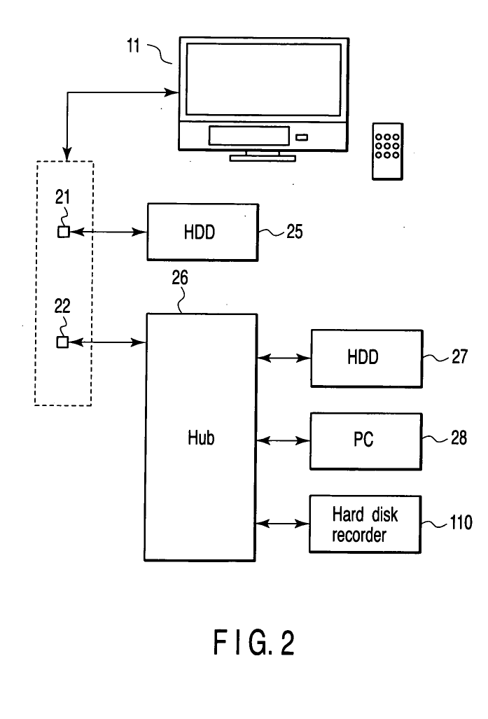

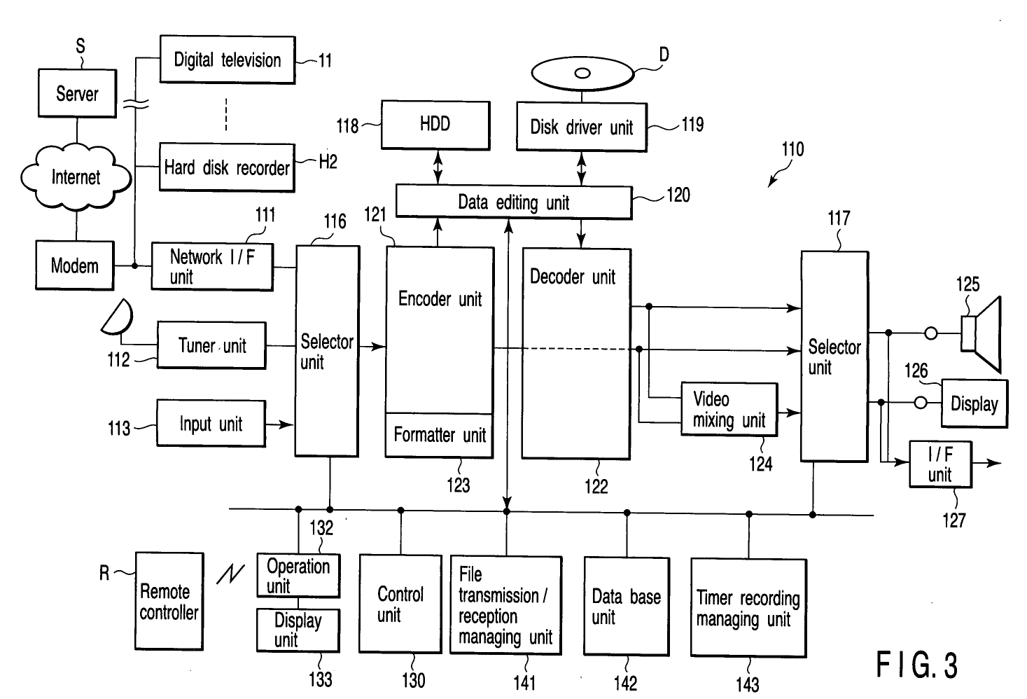

FIG. 1 is a block diagram showing an example of a configuration of a digital television apparatus using a content transmission method according to an embodiment of the invention, FIG. 2 is a network diagram showing an example of a configuration of a network using the content transmission method according to the embodiment of the invention, and FIG. 3 is a block diagram showing an example of a configuration of a recording and reproducing apparatus using the content transmission method according to the embodiment of the invention.

<Digital Television Apparatus According to an Embodiment of the Invention>

First, as an embodiment of the invention, a case of applying the invention to a digital television apparatus having a communication function will be described in detail below with an example of the digital television apparatus 11. FIG. 1 is a block diagram showing an example of the configuration of the digital television apparatus using the content transmission method according to the embodiment of the invention. The digital television apparatus 11 is provided with, for example, an image display 14 of a flat panel type made of a liquid crystal display panel or the like, a speaker 15, an operation unit 16, a light receiving unit 18 for receiving operational information transmitted from a remote controller 17, and the like. In addition, in the digital television apparatus 11, a memory card 19 such as a secure digital (SD) memory card, a memory card such as a multimedia card (MMC) and a memory stick, and further, a memory card (IC card) having, for example, contract information or the like recorded therein, is detachably attached. Information of a program, a photograph and the like is recorded into and reproduced from such memory cards 19, and the information is recorded and reproduced.

In addition, the digital television apparatus 11 has a first local area network (LAN) terminal 21 and a second LAN terminal 22.

In the digital television apparatus 11, a satellite digital television broadcast signal received by an antenna 43 for receiving a BS/CS digital broadcast is supplied to a tuner 45 for a satellite digital broadcast through an input terminal 44, so that a broadcast signal of a desired channel is selected. Then, the broadcast signal selected by the tuner 45 is supplied to a phase shift keying (PSK) demodulator 46 to be demodulated into a digital image signal and a digital voice signal. Thereafter, the demodulated broadcast signals are outputted to a signal processing unit 47.

A digital terrestrial television broadcast signal received by an antenna 48 for receiving a terrestrial broadcast is supplied to a tuner 50 for a digital terrestrial broadcast through an input terminal 49, so that a broadcast signal of a desired channel is selected. Then, the broadcast signal selected by the tuner 50 is supplied to an orthogonal frequency division multiplexing (OFDM) demodulator 51 to be demodulated into a digital image signal and a digital voice signal. Thereafter, the demodulated broadcast signals are outputted to the signal processing unit 47.

Further, an analog terrestrial television broadcast signal received by the antenna 48 for receiving a terrestrial broadcast is supplied to a tuner 52 for an analog terrestrial broadcast through an input terminal 49, so that a broadcast signal of a desired channel is selected. Then, the broadcast signal selected by the tuner 52 is supplied to an analog demodulator 53 to be demodulated into an analog image signal and an analog voice signal. Thereafter, the demodulated broadcast signals are outputted to the signal processing unit 47.

In this case, the signal processing unit 47 selectively performs predetermined digital signal processing, for example, decoding processing of an MPEG 2 with respect to the digital image signal and the digital voice signal that are supplied from the PSK demodulator 46 and the OFDM demodulator 51, respectively, and outputs them to a graphic processing unit 54 and a voice processing unit 55.

Further, the graphic processing unit 54 has a function of overlapping an OSD signal generated by an on-screen display (OSD) signal generating unit 57 on the digital image signal supplied from the signal processing unit 47 and outputting it. The graphic processing unit 54 can selectively output an output image signal of the signal processing unit 47 and an output OSD signal of the OSD signal generating unit 57, and can combine the both output signals and output them such that one output signal composes a half screen and other output signal composed the other half screen.

Then, the digital image signal outputted from the graphic processing unit 54 is supplied to an image processing unit 58. The image processing unit 58 converts the inputted digital image signal into an analog image signal of a format that can be displayed by the image display 14, and then, outputs it to the image display 14 to display an image and guides it to the outside through an output terminal 59.

In addition, the voice processing unit 55 converts the inputted digital voice signal into an analog voice signal of a format that can be reproduced by the speaker 15, and then, outputs it to the speaker 15 to reproduce a voice and guides it to the outside through an output terminal 60.

Here, all the operations of the digital television apparatus 11 including the various reception operations are generally controlled by a control unit 61. The control unit 61 incorporates a central processing unit (CPU) or the like therein. The control unit 61 receives operational information from the operation unit 16, or receives operation information transmitted from the remote controller 17 through the light receiving unit 18, and controls respective units such that the operation content of the control information is reflected thereon.

In this case, the control unit 61 uses a read only memory (ROM) 62 having stored therein a control program to be executed by the CPU and a random access memory (RAM) 63 providing a working space to the CPU.

In addition, this control unit 61 is connected to a card holder 66, to which the memory card 19 can be attached, through a card interface (I/F) 65. Thereby, the control unit 61 can transmit/receive information to/from the memory card 19 attached to the card holder 66 via the card I/F 65. Further, a second memory card (not illustrated) is connected to the control unit 61 to be attachable thereto through a card I/F (not illustrated) and a card holder. Thereby, the control unit 61 can transmit/receive information to/from the second memory card.

The control unit 61 is also connected to the first LAN terminal 21 through a communication I/F 69. This enables to transmit/receive information to/from a LAN-compliant HDD 25 connected to the first LAN terminal 21 via the communication I/F 69. In this case, the control unit 61 has a dynamic host configuration protocol (DHCP) server function, and controls the operations while allocating an internet protocol (IP) address to the LAN-compliant HDD 25 connected to the first LAN terminal 21. Further, an encoding/decoding unit 81 is provided as being connected to the signal processing unit 47 for encoding processing and decoding processing.

Further, the control unit 61 is connected to the second LAN terminal 22 through a communication I/F 70. Thereby, the control unit 61 can transmit/receive information to/from various devices connected to the second LAN terminal 22 (refer to FIG. 1) via the communication I/F 70.

FIG. 2 shows an example of a configuration of a digital board 10, in which the various tuner units 45, 50, and 52; various demodulators 46, 51, and 53; the control unit 61; the signal processing unit 47 and the like are loaded. The configuration of the digital board 10 is merely an example, and it may include other circuits. Further, each block in the drawing is not always provided on the digital board 10 but it can be configured on another substrate. The control unit 61 is also provided with a file transmission/reception managing unit to carry out the file transmission and reception processing, which is an embodiment of the present invention. The file transmission and reception processing may use file management information and may arbitrarily transfer a content file. The file transmission and reception processing will be described in detail later with reference to the drawings.

(Network with Peripheral Device)

As shown in FIG. 2, the digital television apparatus 11 having the above-described configuration configures a network and it is connected to peripheral devices. In other words, in FIG. 2, the first LAN terminal 21 is used, for example, as a LAN-compliant HDD dedicated port, and is used to record and reproduce information by the Ethernet (registered trade mark) to and from the LAN-compliant HDD 25 that is the connected network attached storage (NAS).

In addition, the second LAN terminal 22 is used as a general LAN-compliant port using the Ethernet, and is connected to a LAN-compliant HDD 27, a personal computer (PC) 28, and a hard disk recorder 110 that is reproducible by a digital versatile disk (DVD) or the like, for example, through a hub 26 to be used to transmit/receive information to/from these devices.

<Recording and Reproducing Apparatus According to an Embodiment of the Invention>

Next, a case of applying the invention to a recording and reproducing apparatus as an embodiment of the invention will be described in detail below with an example of a recording and reproducing apparatus 110 such as a hard disk recorder or the like as shown in FIG. 3. According to this embodiment, the recording and reproducing apparatus 110 is illustrated as an apparatus that covers the both of the DVD-RAM and the hard disk as a recording medium. However, the hard disk or the DVD-RAM may be replaced with, for example, a recording medium by a semiconductor memory. Further, a tuner unit having no recording unit such as a set top box is also available. Roughly dividing each block in FIG. 3, a left side shows main blocks of a recording unit and a right side shows a main block of a reproducing unit.

The recording and reproducing apparatus 110 shown in FIG. 3 has two kinds of disk drive units. First, the recording and reproducing apparatus 110 has an optical disk driver unit 119, which rotatably drives an optical disk D as a first media that is an information recording medium capable of constructing a video file and performs reading and writing of information. In addition, the recording and reproducing apparatus 110 has a hard disk drive unit 118 for driving a hard disk as a second media. A control unit 130 is connected to each unit via a data bus so as to control the entire operation.

The recording and reproducing apparatus 110 in FIG. 3 is mainly composed of an encoder unit 121 that configures a recording side, a decoder unit 122 that configures a reproducing side, and the control unit 130 that controls the operation of the apparatus main body. The recording and reproducing apparatus 110 has a selector unit 116 at the input side and a selector unit 117 at the output side. A network I/F unit 111, a tuner unit 112, and an input unit 113 are connected to the selector unit 116 at the input side to output a signal to the encoder unit 121. The recording and reproducing apparatus 110 also has a formatter unit 123 to be connected to the encoder unit 121, a data editing unit 120 for performing desired data processing such as data edit in conjunction with, for example, detection processing for a voice library, the hard disk drive unit 118 to be connected to the data editing unit 120, and the optical disk driver unit 119. Further, the recording and reproducing apparatus 110 has the hard disk drive unit 118, the decoder unit 122 for receiving a signal from the optical disk driver unit 119 and decoding it, the encoder unit 121, the decoder unit 122, the control unit 130, and a video mixing unit 124 for receiving an operational signal from a display unit 133. These respective units are connected to the control unit 130 via the data bus. Further, the output of the selector unit 117 is connected to an external speaker unit 125 and a display unit 126, or, the output is supplied to the external apparatus via an interface unit 127 for performing the communication with the external apparatus.

Also, the recording and reproducing apparatus 110 is connected to the control unit 130 via the data bus, and has an operation unit 132 for receiving the user's operation and the remote controller R's operation. Here, the remote controller can perform operation that is approximately identical to that of the operation unit 132 provided to the main body of the recording and reproducing apparatus 110, and it can perform a recording and reproducing instruction and an editing instruction of the hard disk drive unit 118 and the optical disk driver unit 119, operation of the tuner, and various settings such as setting of the timer recording. Further, the recording and reproducing apparatus 110 has a data base unit 142 that manages library information, library information of the device on the network, and the like, and a timer recording managing unit 143 that performs timer recording by using the hard disk drive unit 118 and the optical disk driver unit 119 in conjunction with the data base unit 142 or not in conjunction therewith. In addition, the recording and reproducing apparatus 110 has a file transmission/reception managing unit 141 that manages file transfer processing via the network, which is an embodiment of the present invention, and the file transfer processing will be described in detail later with reference to the drawings.

(Basic Operation)

The summary of the reproducing processing and the recording processing in the recording and reproducing apparatus configured in this way will be described below taking an example of an optical disk. Under the control of the control unit 130, the optical disk D rotating at a predetermined speed irradiates a laser beam and the reflection light is detected by an optical pickup, and then, a detection signal S based on the detection is outputted. On the basis of the detection signal S, an RF signal is generated and the reproducing processing is carried out.

Under the control of the control unit 130, according to the recording processing of the optical disk, the data supplied, for example, through the input unit 13 and the selector unit 116 is temporarily accumulated in a storage area of the voice library managing unit 42, to be supplied to the encoder unit 121. Then, the data is coded to be outputted. In accordance with the coded output and the output of the control unit 130, a driving current of a laser driver 165 is supplied to an optical pickup 151 and is irradiated on the storage area of the optical disk D, so that the recording processing is carried out.

<File Transmission and Reception Processing According to an Embodiment of the Invention>

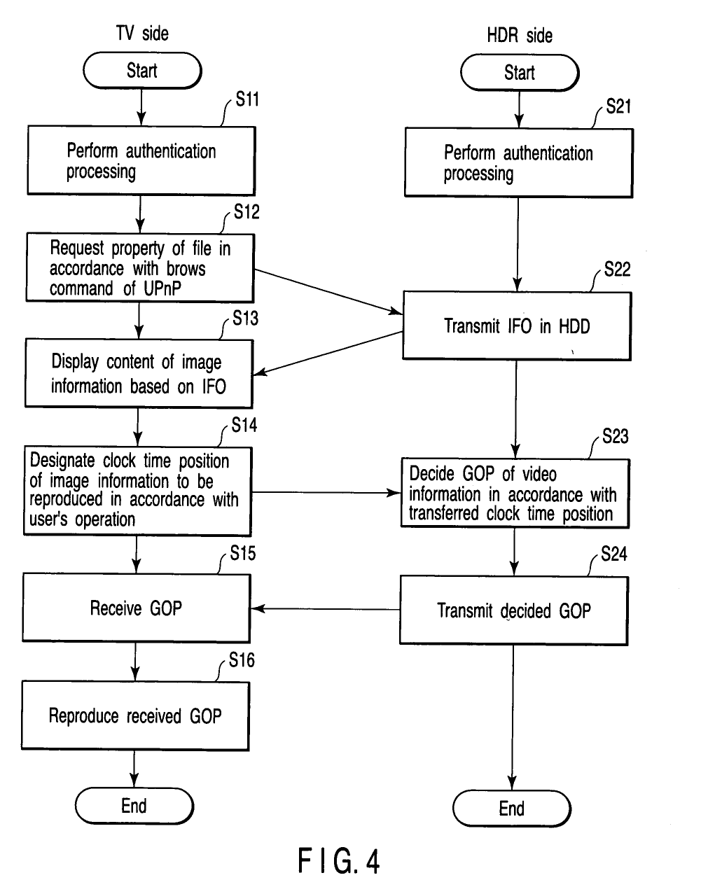

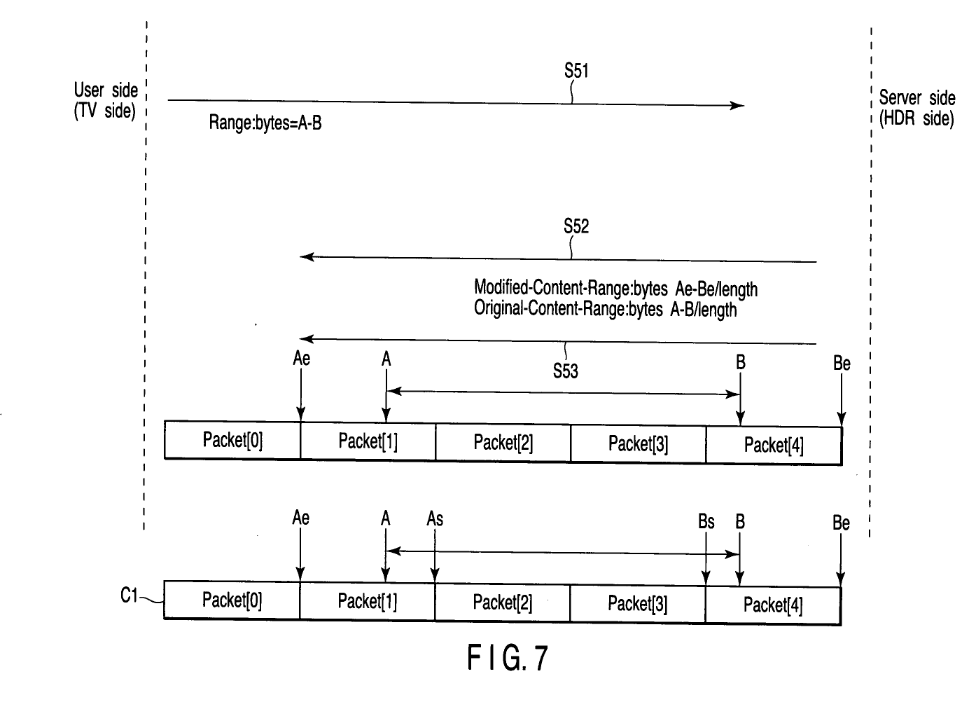

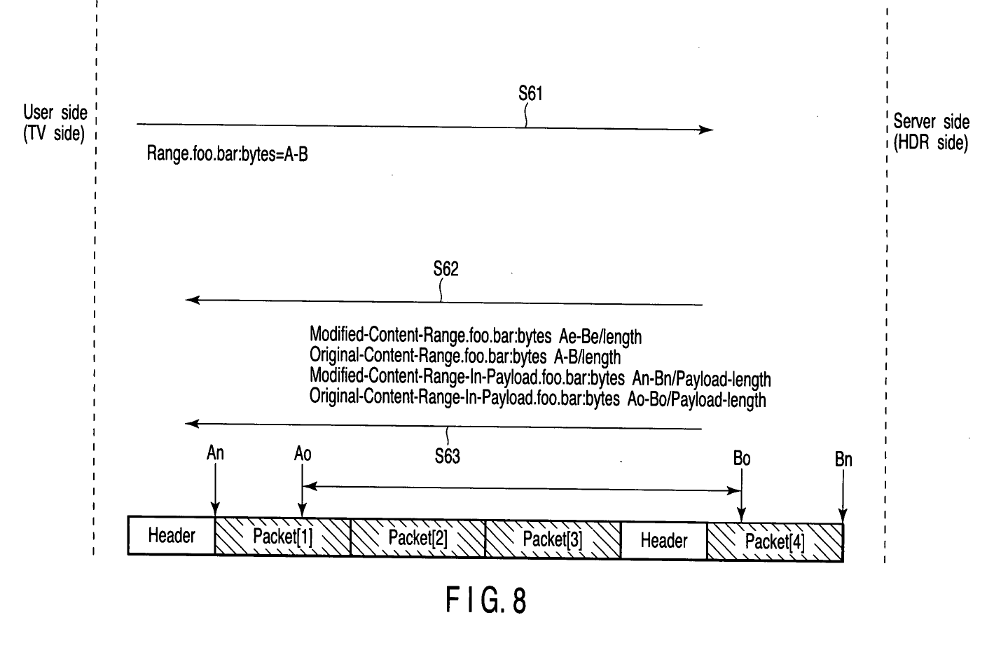

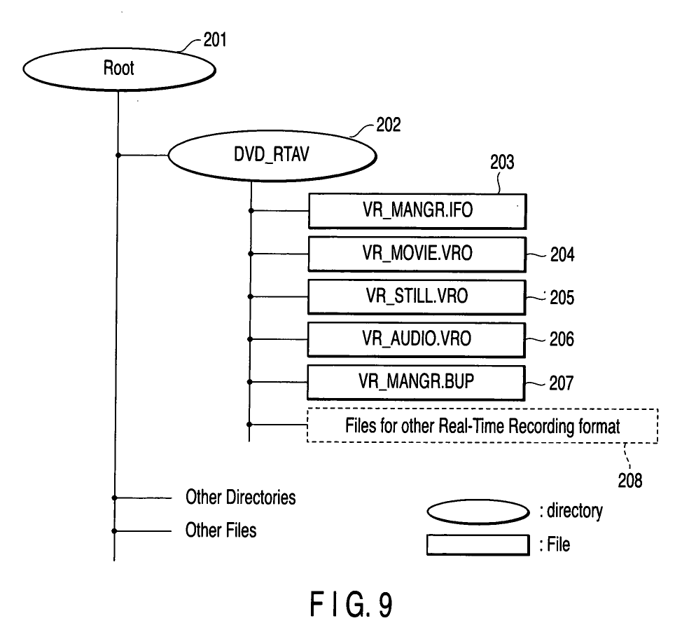

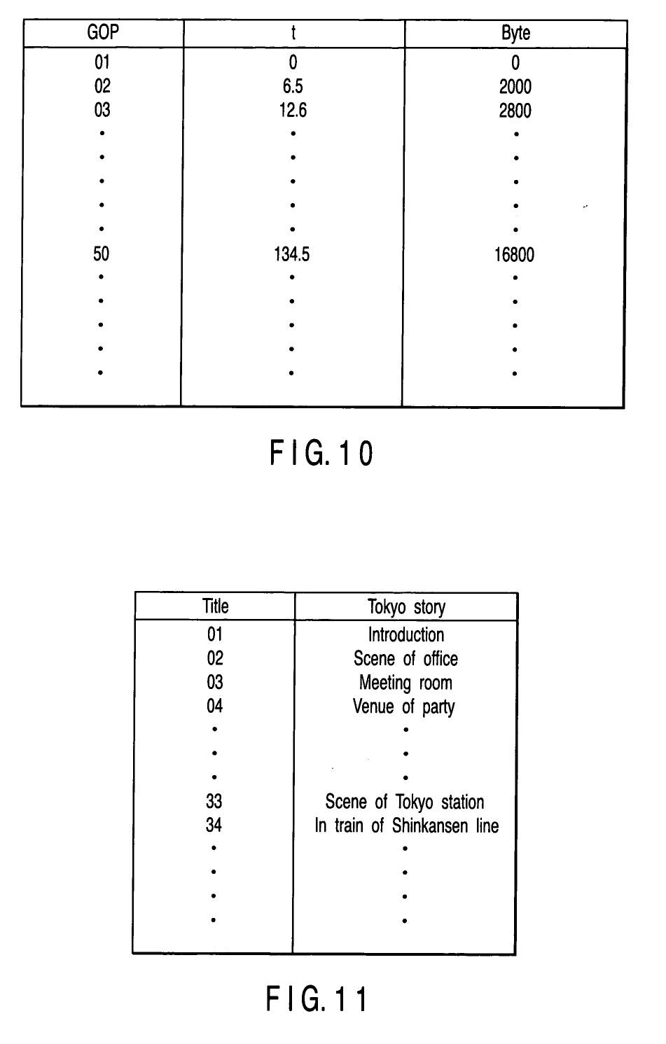

Next, the file transmission and reception processing between the digital television apparatus and the recording and reproducing apparatus will be described in detail below. In the file transmission and reception processing according to an embodiment of the invention, for example, a case where a content is transmitted and received between the side of the digital television apparatus and the side of the recording and reproducing apparatus will be described. FIGS. 4 to 6 are flow charts each showing an example of a content transmission method according to an embodiment of the invention; FIGS. 7 and 8 are explanatory views showing a step of designating a content packet and a step of transmitting the content packet in the content transmission method according to the embodiment of the invention; FIG. 9 is an explanatory view showing an example of a data configuration of content information that is subject of the content transmission method according to the embodiment of the invention; FIG. 10 is an explanatory view showing an example of a data configuration of content information that is subject of the content transmission method according to the embodiment of the invention; and FIG. 11 is an explanatory view showing an example of a title screen displayed by a recording and reproducing apparatus using the content transmission method according to the embodiment of the invention.

The reproducing apparatus, which is an embodiment of the invention (for example, a digital television and a main hard disk recorder), not only transfers a content owned by the device such as the hard disk recorder on the network, for example, an MPEG2TS (Transport Stream) to the digital television or the like, but also acquires only management information (VR MANGR.IFO) of a content with a very small capacity. Hereinafter, this operation will be described in detail with reference to the flow chart shown in FIG. 8.

Here, the operation of collecting the management information of the content file (VR_MANGR.IFO) from the hard disk recorder 110 or the like by a file transmission/reception managing unit 64 of the digital television apparatus 11 in conjunction with the working of the file transmission/reception managing unit 141 of the hard disk recorder 110 on the network so as to transmit and receive necessary packets, will be described.

(Packet Transmission and Reception Processing: GOP Decision at Transfer Destination)

First, in the digital television apparatus 11, under the operations of the control unit 61 and the file transmission/reception managing unit 64, access is made to the hard disk recorder 110 on the network through the communication I/F 70 and authentication processing is performed (S11). At the same time, authentication processing is carried out also in the hard disk recorder 110 (S21). If the authentication processing is successfully achieved, the digital television 11 requests a property of the content file, namely, management information in accordance with a brows command of UPnP due to the operation of the file transmission/reception managing unit 64 (S12).

The management information becomes VR_MANGR.IFO 203 shown in FIG. 9, for example, in an MPEG2-TS (Transmission Stream). Here, FIGS. 9 and 10 are explanatory views showing an example of the data configuration of the content information (MPEG2-TS) that is subject of the content transmission method according to the embodiment of the invention. Here, Root 202 of MPEG2-TS has VR_MANGR.IFO 203, VR_MOVIE.VRO 204, VR_STILL.VRO 205, VR_AUDIO.VRO 206, VR_MANGR.BUP 207, and File for other Real-Time Recording format 208 as the management information of this time.

Further, the VR_MANGR.IFO 203 has relational information from among a GOP (Group Of Packet) number, a reproduction time t, and a capacity as a portion of its function. By using this, even if the user designates the reproduction time, for example, the VR MANGR.IFO 203 can decide a necessary packet for this. In addition, the VR_MANGR.IFO 203 further has information indicating what chapter configuration the file has as shown in FIG. 9.

Here, in the hard disk drive unit 118 of the hard disk recorder 110 or the like, the VR_MANGR.IFO 203 or the like which is the management information of the content file such as the stored MPEG2TS or the like is transferred to the digital television 11 via the network I/F unit 111 by means of management due to the file transmission/reception managing unit 141 or the like (S22).

Receiving the VR_MANGR.IFO 203 or the like which is the management information of the digital television 11, the digital television 11 temporarily stores it, for example, in the RAM 63, and in conjunction with the content indicated by the IFO 203, the digital television 11 displays the content of the chapter, for example, as shown in FIG. 11 (S13). It is preferable that the content of the chapter is displayed on the image display 14 as it is; in accordance with the operation of the user, for example, only the title of the content on the network is displayed; and if the user selects the title, in accordance with this selection instruction, the chapter of “Tokyo Story” is displayed as shown in FIG. 11. However, the present embodiment is not limited thereto.

Then, if the reproduction time and the reproduction time clock of an image to be reproduced are designated by the operation of the user who views this screen, the time information is transmitted to the hard disk recorder 110 via the communication I/F 70 (S14).

In this case, there are various methods of instruction, and for example, a start time or an end time may be designated and the chapter to be reproduced may be designated. In addition, another method of instruction is available. Here, a case where the start time and the end time are designated will be described. However, the hard disk recorder 110 having the start time and the end time given thereto may determine the GOP in accordance with the start time and end time on the basis of the corresponding information shown in FIG. 10 owned by the VR_MANGR.IFO 203 (S23). For example, the reproduction GOPs 42 to 52 is decided, and only the image and voice information of the decided GOP are transferred to the digital television apparatus 11 via the network I/F unit 111 (S24).

The digital television apparatus 11 receives the GOPs 47 to 52 transmitted via the hard disk recorder 110 via the communication I/F 70, and decodes and reproduces it by the signal processing unit 47 (S16). Thereby, since a block of the content files is not entirely transferred every time as the prior art, the very small transfer amount is required. This enables the user to manage all the contents on the network in the digital television apparatus 11 by chapters. Further, the user can immediately reproduce the content in accordance with the designated time or by chapters according to at request. In addition, the case where the content of the hard disk recorder 110 on the network is reproduced from the digital television apparatus 11 is explained here. However, on the contrary, it is also possible to refer to the file of the storage area of the digital television apparatus 11 from the hard disk recorder 110 and acquire it, and further, it is also possible to transfer the file from the other device on the network in the same way.

(Decide Transmit Packet Based on GOP with Range Designation Changing Method: Decide GOP at Transfer Destination)

In the meantime, in step S23, the user instructs the reproduction due to the instruction by the chapter designation, the temporal instruction, and the capacity instruction in the hard disk recorder 110. In this case, it is preferable to instruct the reproduction by a range designation changing method. Here, in the range designation changing method, according to a timing chart of a packet shown in FIG. 7, a start time A and an end time B designated by the user (the capacity designation is the same) are not always identical to the start position and the end position of the packet. For this reason, it is necessary to decide the packet to be finally reproduced by the extended interpretation and the narrowed interpretation. According to the range designation changing method, the user instructs whether the extended interpretation or the narrowed interpretation is carried out with respect to the user instruction.

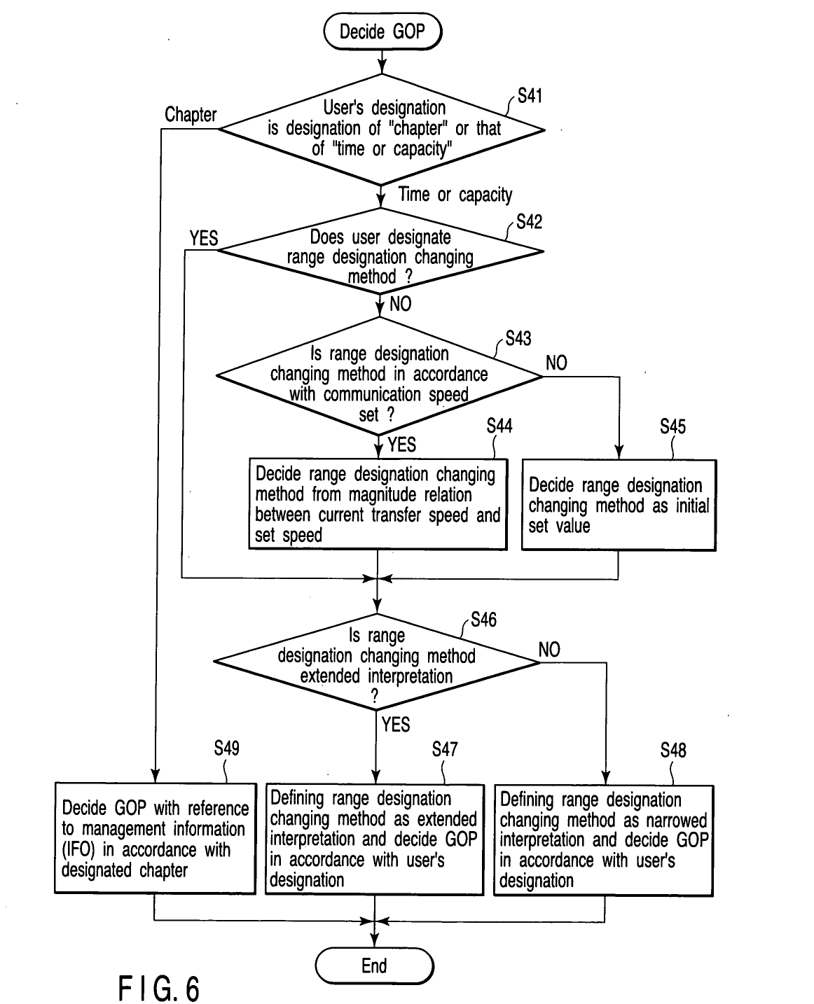

In other words, when the user instructs the reproduction position due to the instruction by the “chapter” designation in the flow chart of FIG. 6, the hard disk recorder 110 decides the GOP with reference to the management information (IFO) in accordance with the designated chapter (S49). In the case where the user's instruction is one by “time information or capacity information”, the hard disk recorder 110 determines whether or not the instruction of the range instruction changing method is transmitted from the user (S42). Here, the range instruction changing method may be transmitted from the digital television apparatus 11 together with the instruction of the reproduction position from the user, or it may be instructed independently. If the range instruction changing method from the user is designated, it is checked whether or not this range instruction changing method is the extended interpretation (S46). If it is the extended interpretation, the instruction from the user is extendedly interpreted to decide the GOP (S47). As shown in the timing chart C1 of FIG. 7, the times A and B are made into times Ae and Be according to the extended interpretation, and this results in that the packets 1 to 4 are decided to be reproduction packets.

In the same way, if the range instruction changing method designates the narrowed interpretation (S46), limitedly interpreting the instruction from the user, the GOP is decided (S48). As shown in the timing chart C1 of FIG. 7, the times A and B are made into times As and Bs according to the narrowed interpretation, and this results in that the packets 2 and 3 are decided to be reproduction packets.

In the case where no range instruction changing method is transmitted from the user, it is preferable that an automatic determination function is provided as a specification set by the user or set in shipment in advance, which determines whether or not the extended interpretation is effected depending on whether the communication speed of the network I/F unit 111 of the hard disk recorder 110 excesses a predetermined value or not (S43). This determination considers that increase of the number of the transfer packets is not a burden if the rapid communication speed can be kept. Here, if the automatic determination of the communication speed is set, the extended interpretation and the narrowed interpretation are decided in accordance with the speed, and the processing equal to those on and after step S46 is carried out.

Further, even when the automatic determination due to these user's instructions and the communication speed is not carried out, the determination processing is carried out in accordance with this interpretation if the extended interpretation or the narrowed interpretation is decided as the initial set value (S45). Generally, it is preferable to decide the extended interpretation as the initial set because the screen at starting and the screen at ending are not omitted when the time instruction or the like is carried out. However, if the processing capability is not satisfactory, the narrowed interpretation is also effective as an option.

In the meantime, in FIGS. 7 and 8, as the method to designate the range of the reproduction position from the user, an example of the designation method due to a character line. In FIG. 7, if the user designates the range as “Range: bytes=A-B” (S51), correspondingly, the hard disk recorder 110 transmits a declaration statement of Modified-Content-Range: byte Ae-Be/length, Original-Content-Range: bytes A-B/length” (S52), and then transfers the real packet to the digital television apparatus 11 (S53). Thus, the digital television apparatus 11 can discriminate the fact that the packet, of which range is partially changed by the range instruction changing method, is transmitted, so that the error operation is not generated and this enables to improve the operation reliability.

In the same way, in FIG. 8, a header is further added. Therefore, if the user designates the range as “Range.foo.bar: bytes=A-B” (S61), correspondingly, the hard disk recorder 110 transmits the declaration statement of “Modified-Content-Range.foo.bar: byte Ae-Be/length, Original-Content-Range.foo.bar: bytes A-B/length, Modified-Content-Range-In-Payload.foo.bar: byres An-Bn/payloard-length, Original-Content-Range.-In-Payload.foo.bar: bytes Ao-Bo/payload-length” (S62), and then, it transfers the real packet to the digital television apparatus 11 (S63). In the same way, this enables the digital television apparatus 11 to certainly recognize that the packet, of which range is partially changed by the range instruction changing method, is transmitted, so that the operation reliability can be improved.

(Packet Transmission and Reception Processing: GOP is Decided at Operation Origin)

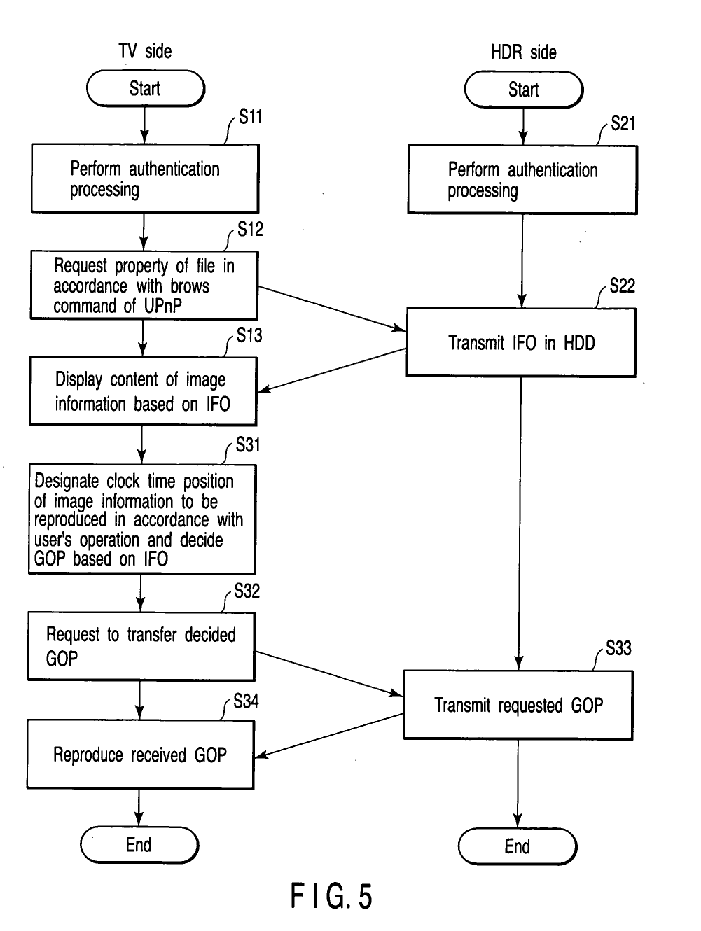

Next, with reference to the flow charts in FIGS. 5 and 6 and the explanatory views of FIGS. 7 and 8, a case where the Transmit Packet is decided in the digital television apparatus that is the operation origin will be described below.

First, in the digital television apparatus 11, according to the operations of the control unit 61 and the file transmission/reception managing unit 64, access is made to the hard disk recorder 110 on the network via the communication I/F 70, and authentication processing is carried out (S11). At the same time, authentication processing is carried out also in the hard disk recorder 110 (S21). If the authentication processing is successfully achieved, the digital television apparatus 11 requests a property of a content file, namely, management information in accordance with a brows command of UPnP by the operation of the file transmission/reception managing unit 64 (S12).

For example, in the MPEG2-TS, this management information becomes VR_MANGR.IFO 203 shown in FIG. 9. Here, in the hard disk drive unit 118 of the hard disk recorder 110 or the like, the VR_MANGR.IFO 203 or the like which is the management information of the content file such as the stored MPEG2TS or the like is transferred to the digital television 11 via the network I/F unit 111 by means of management due to the file transmission/reception managing unit 141 or the like (S22).

Receiving the VR_MANGR.IFO 203 or the like which is the management information of the digital television 11, the digital television 11 temporarily stores it, for example, in the RAM 63, and in conjunction with the content indicated by the IFO 203, it displays the content of the chapter, for example, as shown in FIG. 11 (S13). It is preferable that the content of the chapter is displayed on the image display 14 as it is; in accordance with the operation of the user, for example, only the title of the content on the network is displayed; and if the user selects the title, in accordance with this selection instruction, the chapter of “Tokyo Story” is displayed as shown in FIG. 11.

Here, if the reproduction time and the reproduction clock time of the image to be reproduced are designated by the operation of the user who views this screen, the information it not to transferred to the hard disk recorder 110 as it is, but, under the working of the file transmission/reception managing unit 64, the digital television 11 determines the GOP in accordance with the designated start time and end time on the basis of the corresponding information shown in FIG. 10 owned by the VR_MANGR.IFO 203. Alternatively, the digital television 11 decides the GOP according to the designated chapter in accordance with the information of the VR_MANGR.IFO 203 (S31). Then, the digital television 11 requests the transfer of the decided GOP from the hard disk recorder 110 (S33).

In the meantime, also in the case of deciding the GOP by its own device in step S31, as shown in the flow chart of FIG. 6, the range designation changing method given by the user, or the range designation changing method due to the speed, or the range designation changing method of the initial set is applied. Since the range designation changing method upon decision of the GOP in the step S31 is the same as that upon decision of the GOP in the step S23, the detailed explanation thereof is herein omitted.

The digital television 11 receives the GOP transmitted from the hard disk recorder 110 via the communication I/F 70, decodes it by the signal processing unit 47, and reproduces it (S34).

According to the method, the user can know, for example, what the contents of 50 titles held by the hard disk recorder at 2F are, for example, in the network system as shown in FIG. 2. Further, by acquiring the management information of each title, the user can know into what chapters or the like this content is divided. In other words, by analyzing the management information acquired in this way, the digital television or the like having the communication function at 1F can display a plurality of contents held by the recorder at 2F on the television screen as a list, and further, the user also can know from what chapters each content is constructed. Therefore, the user can designate one content from among these contents, can designate only a specific chapter from among the contents, and can designate the time. It can be discriminated to what packet the moving image and voice information corresponding to the time and the chapter designated by the user correspond by referring to the management information (VR_MANGR.IFO). Then, if the packet to be transferred is decided, the user acquires only this packet from the hard disk recorder via the network.

Consequently, only by transferring the management information with a very small capacity and a specific packet, the user can minimize the transfer amount and can view respective chapters of all the contents connected to the network as a viewable object to be selected while easily browsing them on the screen.

In addition, according to the above-described embodiment, the content file is explained with respect to the MPEG2TS. However, the present invention is not limited to this file system but it can correspond to other systems of the MPEG2, another MPEG system such as an MPEG4, or another image and voice file system other than the MPEG.

As described in detail above, in the reproducing apparatus that is an embodiment of the invention (for example, the digital television and the main hard disk recorder), the user may not merely transfer the content held by the device such as a hard disk recorder on the network, for example, the MPEG2TS (Transport Stream) but may acquire only the management information (VR MANGR.IFO) of the content with the very small capacity. Thereby, for example, the user can know what the contents of fifty titles held by the hard disk recorder at 2F are. Further, by acquiring the management information of each title, the user can know into what chapters or the like this content is divided.

In other words, by analyzing the management information acquired in this way, the digital television or the like having the communication function at 1F can display a plurality of contents held by the recorder at 2F on the television screen as a list. Further, the user also can know from what chapters each content is constructed. Therefore, the user can designate one content from among these contents, can designate only a specific chapter from among the contents, and can designate the time. It can be discriminated to what packet the moving image and voice information corresponding to the time and the chapter designated by the user correspond by referring to the management information (VR_MANGR.IFO). Then, if the packet to be transferred is decided, the user acquires only this packet from the hard disk recorder via the network.

Thereby, only by transferring the management information with a very small capacity and a specific packet, the user can minimize the transfer amount and can view respective chapters of all the contents connected to the network as a viewable object to be selected while easily browsing them on the screen.

In addition, in the case where the reproduction position given by the user is the time information or the capacity information, it is not possible to uniquely specify the GOP to be reproduced necessarily and the user should select the expanded interpretation or the narrowed interpretation. According to the embodiment of the present invention, when the user gives the interpretation as the range instruction changing method, the optimum changing method is applied so as to improve the operational reliability.

According to the above-described various embodiments, a person skilled in the art can realize the present invention. Further, it could be easily made by a person skilled in the art to make various modified examples of these embodiments and without an inventive capability, the present invention can be applied to various embodiments. Accordingly, the present invention covers a broad range that is consistent to a disclosed principle and a new characteristic, so that it can be said that the present invention is not limited to the above-described embodiments.

What is claimed is:

1. A reproducing apparatus comprising:
a communication unit configured to perform communication with a device on a network;
a reproducing unit configured to decode a content in units of packets and reproduce it; and
a control unit configured to control to acquire management information (IFO) of the content stored in the device on the network by controlling the communication unit, to display the substance of the content on the basis of the management information, to receive a reproduction instruction from a user in accordance with the display, to acquire the content on the device in units of packets via the communication unit in accordance with the reproduction instruction, and to reproduce the packet of the acquired content by the reproducing unit.

2. The reproducing apparatus according to claim 1, wherein the control unit decides a packet to be acquired from among a plurality of packets configuring the content by narrowing or extending a range indicated by the reproduction instruction from the user in accordance with a range designation changing method designated by the user.

3. The reproducing apparatus according to claim 1, wherein, when a range indicated by the reproduction instruction from the user is time information of the content or a byte size of the content, the control unit decides a packet to be acquired from among a plurality of packets configuring the content by narrowing or extending the range of the time information or the range of the content byte size in accordance with a range designation changing method designated by the user.

4. The reproducing apparatus according to claim 1, wherein, when a communication speed of the communication unit is not less than a predetermined speed, the control unit decides a packet to be acquired from among a plurality of packets configuring the content in accordance with a range indicated by the reproduction instruction from the user or by extending the range.

5. The reproducing apparatus according to claim 1, wherein the control unit designates a range for reproduction instructed by the user by transmitting a character line, and in accordance with this, when receiving the character line indicating that the designated range is changed and the packet is specified from the device on the network, the control unit discriminates that the designated range is changed.

6. The reproducing apparatus according to claim 1, wherein the control unit determines which packet among a plurality of packets configuring one content indicated by the management information corresponds to the reproduction instruction, and controls to acquire only the selected packet from the device on the network via the communication unit.

7. The reproducing apparatus according to claim 1, wherein the management information of the content to be acquired by the control unit is a VR MANGR.IFO file.

8. The reproducing apparatus according to claim 1, wherein the control unit controls to generate image display information for displaying a chapter title of the content and output it on the basis of management information of the acquired content.

9. The reproducing apparatus according to claim 1, wherein the control unit generates information based on management information of the acquired content and outputs it; and if the user instructs the response by the time information in order to acquire a portion of the content from the device on the network, the control unit determines to which packet among a plurality of packets configuring the content the time information correspond on the basis of the management information; and acquires and reproduces only the corresponding packet from the device on the network.

10. The reproducing apparatus according to claim 5, wherein the control unit determines one or plural packets so as to acquire at least all images designated by time information designated by the user from the management information, and controls to acquire the determined one or plural packets.

11. The reproducing apparatus according to claim 1, further comprising a storage unit configured to store a second content and its management information,
wherein, if the device on the network requires a transmission of the management information, the control unit controls the communication unit to transmit the management information.

12. The reproducing apparatus according to claim 7, wherein the management information of the second content stored in the storage unit is a VR MANGR.IFO file.

13. The reproducing apparatus according to claim 7, wherein, if the control unit is required to transmit a portion of the packet among a plurality of packets configuring the second content from the device on the network, the control unit controls the communication unit to transmit the portion of the packet.

14. A reproducing apparatus comprising:
a communication unit configured to perform communication with a device on a network;
a storage unit configured to store a content and its management information; and
a reproducing unit configured to reproduce the content,
wherein, if the control unit is required to transmit the management information from the device on the network, the control unit controls the communication unit to transmit the management information.

15. A reproducing method comprising:
acquiring management information (IFO) of a content which is stored in a device connected to a reproducing apparatus via a network by performing communication with the device;
displaying the substance of the content on the basis of the management information;
receiving a reproduction instruction from a user in accordance with the display, and acquiring the content on the device in units of packets via the network in accordance with the reproduction instruction; and
reproducing the packet of the acquired content.

16. The reproducing method according to claim 15, further comprising:
when a reproduction instruction from the user is received, determining which packet among a plurality of packets configuring one content indicated by the management information corresponds to the reproduction instruction, and controlling to acquire only the selected packet from the device on the network.

17. The reproducing method according to claim 15, wherein the management information of the content is a VR_MANGR.IFO file.

18. The reproducing method according to claim 15, further comprising:
controlling to generate image display information for displaying a chapter title of the content and output it on the basis of the management information of the acquired content.

19. The reproducing method according to claim 15, further comprising:
generating information on the basis of management information of the acquired content and outputting it;
if the user instructs the response by time information in order to acquire a portion of the content from the device on the network, determining to which packet among a plurality of packets configuring the content the time information correspond on the basis of the management information, and acquiring and reproducing only the corresponding packet from the device on the network.

20. A reproducing method comprising:
storing a content and its management information in a storage area of a reproducing apparatus; and
if a device connected to the reproducing apparatus via a network requires to transmit the management information, controlling to transmit the management information.
